(19) United States
(12) Patent Application Publication
(10) Pub. No.: US 2024/0017423 A1
(43) Pub. Date: Jan. 18, 2024

(54) DEVICE FOR HANDLING OF CONVEYED GOODS WITHIN A BARRIER SYSTEM

(71) Applicant: Syntegon Technology GmbH, Waiblingen (DE)

(72) Inventors: Stefan Nagler, Unterschneidheim (DE); Ulrich Krauß, Ilshofen (DE); Markus Ilgenfritz, Feuchtwangen (DE); Samuel Stegmeier, Wuestenau (DE)

(21) Appl. No.: 18/352,456

(22) Filed: Jul. 14, 2023

(30) Foreign Application Priority Data
Jul. 14, 2022 (DE) 10 2022 117 631.2

(51) Int. Cl. B25J 15/06; B25J 21/00

(52) U.S. Cl. CPC B25J 15/0608; B25J 21/005

(57) ABSTRACT

A device (1) for handling of conveyed goods (2) within a barrier system (3), comprising a manipulator (4) arranged in the barrier system (3) and having a magnetic actuator (5) for applying a magnetic force (6) to the conveyed goods (2), having a design-dependent magnetic acting direction (6) of the magnetic force (7), wherein the manipulator (4) is arranged inside the barrier system (3) and is adapted to coupling the conveyed goods (2) with the magnetic force (7) to the manipulator (4) and moving them with the manipulator (4) within the barrier system (3).

### BACKGROUND

The invention relates to a device for handling of conveyed goods within a barrier system, being especially suited to interacting with a transfer device by which conveyed goods can be brought into the barrier system or brought out from the barrier system. Such a transfer device is especially suited to transporting the conveyed goods under barrier system conditions and preferably itself forms a kind of small barrier system. Such a transfer device can preferably be connected to a docking port of the barrier system and then be opened so that the conveyed goods can be transported from the transfer device to the barrier system or vice versa.

Systems consisting of a barrier system and a transfer device form an overall system for the handling of conveyed goods. The barrier system can be a clean room, for example. The barrier system can also be a system for the safe handling of contaminated materials which need to be safely prevented from getting into the environment.

Basically, it is desirable to process conveyed goods in barrier systems and clean rooms with the fewest possible manual operator interventions. In particular, operator interventions by hand (such as through glove ports) are costly and problematical and should be avoided as much as possible. Furthermore, the safest possible process handling of conveyed goods in clean rooms is desired, which can be done without the occurrence of mistakes or disturbed conditions. Mistakes and disturbed conditions are usually especially problematical during the handling of conveyed goods in clean rooms, because the access is of course limited in a barrier system in order to be able to maintain the barrier system conditions.

### SUMMARY

The problem addressed by the present invention is to solve the issues, at least in part, as discussed in relation to the prior art. In particular, a device should be proposed for the handling of conveyed goods in clean rooms which makes possible an effective handling and affords a good safety of processing.

This problem is solved with the invention according to the features disclosed. Further advantageous embodiments are indicated in the claims and in the description and especially also in the description of the figures. It should be pointed out that the person skilled in the art will combine the individual features in a technologically meaningful manner and thereby arrive at further embodiments of the invention.

There shall be described here a device for the handling of conveyed goods within a barrier system, comprising a manipulator arranged in the barrier system and having a magnetic actuator for applying a magnetic force to the conveyed goods, having a design-dependent magnetic acting direction of the magnetic force, wherein the manipulator is arranged inside the barrier system and is adapted to coupling the conveyed goods with the magnetic force to the manipulator and moving them with the manipulator within the barrier system.

The device comprises in particular the manipulator, which can be arranged inside the barrier system, or which can be provided for the arrangement within the barrier system. The device is preferably part of a barrier system.

The manipulator can be, for example, a robot arm or a similar device, preferably having a manipulator head, which can be moved deliberately inside the barrier system. The magnetic actuator is preferably arranged on the manipulator head. The manipulator is preferably electrically driven. The manipulator preferably has a plurality of manipulator arm segments arranged on one another, being connected to each other by joints. On a last manipulator arm segment there is preferably arranged the manipulator head. The joints are preferably activated with electrical drive units, in order to move the manipulator arm segments relative to each other. The electrical drive units of the manipulator are preferably actuated by a con-troller in order to achieve targeted movements of the manipulator or the manipulator head with the magnetic actuator.

It is especially preferable for the magnetic actuator to comprise at least one electromagnet.

The magnetic actuator can be designed optionally with permanent magnets or electromagnets. In preferred variant embodiments, the magnetic actuator can be activated and deactivated. This means that the magnetic force generated by the magnetic actuator can preferably be activated and deactivated deliberately—for example, switched on or off. In such variant embodiments, the magnetic actuator is configured at least partly with electromagnets. In further variant embodiments, the magnetic actuator is adapted such that the magnetic force is permanently active, at least in part. In such variant embodiments, the magnetic actuator is configured at least partly with permanent magnets.

The design-related magnetic acting direction of the magnetic actuator is preferably dictated by the arrangement of the magnets within the magnetic actuator. An orientation of the magnetic acting direction in space can be influenced by changing the orientation of the magnetic actuator with the manipulator. By the magnetic acting direction is meant the direction in which an attraction or repulsion occurs due to the magnetic forces. This is not to say that there is no action of the magnetic actuator in other directions. However, a metal part arranged freely movable with regard to the magnetic actuator would be attracted with the magnetic acting direction of the magnetic actuator. The magnetic acting direction can be re-garded, e.g., as the principal direction component or as the mean acting direction of the magnetic forces of the magnetic actuator. The magnetic acting direction is preferably parallel to an axis running through the north pole and the south pole of a magnet.

By a “coupling” of the conveyed goods to the manipulator with the use of the magnetic force is meant that the conveyed goods and the manipulator are temporarily held together by the magnetic force, so that a magnetic coupling of the conveyed goods and the manipulator results. Due to a movement of the manipulator, a movement of the conveyed goods also results.

Various ways can be implemented to achieve a coupling of the manipulator with the conveyed goods, without this resulting in disturbances. An undesirable disturbance would be, for example, when magnetic forces occur at a particular point during the approaching of the magnetic actuator to the conveyed goods and they cause an uncontrolled movement of the conveyed goods relative to the manipulator. Such situations can be avoided, for example, by only activating the magnetic actuator and the magnetic force when the magnetic actuator finds itself in a coupling position, for example. Another possibility is to design the manipulator so that it approaches the conveyed goods from a direction or with a particular orientation in which little or no magnetic forces are acting on the conveyed goods before the coupling ac-tually occurs. In further variant embodiments, means are provided by which the conveyed goods are held in a prescribed position until such time as a coupling occurs between the conveyed goods and the manipulator.

The movement of the conveyed goods with the manipulator and the magnetic actuator in the barrier system has significant advantages over the manual movement through glove ports, because it makes possible an automated processing.

Considerable advantages also exist as compared to the handling with robots having grips with gripping jaws, because the producing of the coupling via magnetic forces can be done very gently and in particular no mechanical interaction of a grip with the conveyed goods can cause damage or impairment to the conveyed goods. Furthermore, gripping jaws of a grip (even if they are inside the barrier system) are always a risk of contamination of the barrier system conditions, because such gripping jaws are in contact with a multitude of conveyed goods or samples in succession.

Glove ports are furthermore pharmaceutically problematical when the conveyed goods involve for example a pharmaceutical or medical samples. With the device described here, it is possible to reduce the use of glove ports to a minimum or even eliminate it entirely. Glove ports can generate particles which contaminate the interior of the barrier system or the conveyed goods.

The virtue of the solution described here is the arrangement of the manipulator with the magnetic actuator within the barrier system. From this position, a very efficient handling of the conveyed goods with the manipulator can be accomplished inside the barrier system.

Thanks to the arrangement of the manipulator with the magnetic actuator in the barrier system, it is possible in particular to use magnetic forces with a very short active dis-tance from the conveyed goods. For this reason, the magnetic forces of the magnetic actuator need not be very large. Magnetic fields preferably extend only in the immediate surroundings of the magnetic actuator.

It is especially advantageous when the manipulator is adapted to moving the conveyed goods with a direction of movement having at least one direction component parallel to the magnetic acting direction of the magnetic force.

Furthermore, it is advantageous when the magnetic acting direction of the magnetic force and the direction of movement of the conveyed goods run in parallel.

Such an arrangement is to be distinguished from an arrangement in which magnetic forces are used in the manner of a linear drive and in which the direction of movement is perpendicular to the magnetic acting direction. Thanks to the movement parallel to the magnetic acting direction, relatively small magnetic forces can be utilized in order to achieve a strong or firm coupling. Moreover (unlike the case of a linear drive), it is very hard to de-tach the coupling, because the coupling occurs preferably against a mechanical stop and for this reason the coupling forces can be larger than are needed. By a stop is meant here that the magnetic actuator and the conveyed goods preferably lie against each other and there is a mechanical counter-pressure force of the conveyed goods and the magnetic actuator relative to each other. The interplay of magnetic force and mechanical counter-pressure force has the effect that the coupling produced with the device is robust to various forces of resistance (fric-tion, etc.) during the movement of the conveyed goods.

Furthermore, it is advantageous when the conveyed goods comprise a material with magnetic properties.

In such variant embodiments, the conveyed goods are themselves magnetic. For example, the conveyed goods can be a metallic sample or the like.

Furthermore, it is advantageous when the conveyed goods are a transport container and/or at least one container for a material. Preferably, samples or the like are arranged in the transport container and/or the container. Especially preferably, the container or the transport container is a carrier for a plurality of samples, such as a sample array. Transport containers are also regularly known as format pieces. For example, they may contain a number of glass containers (such as small Petri dishes, test tubes, etc.), which in turn contain samples. In principle, all the parts required in a barrier system for the particular task being performed are transported with the device described herein.

Furthermore, it is advantageous when the magnetic actuator is arranged on a manipulator head, which can turn about an axis of rotation oriented parallel to the magnetic acting direction.

With a rotatable manipulator head, an angular orientation of the manipulator head relative to the axis of rotation can be easily adjusted. Preferably, there is an electrical drive unit for turning the manipulator head deliberately about the axis of rotation.

Furthermore, it is advantageous when the conveyed goods comprise a coupling element having magnetic properties.

Preferably, the coupling element is fastened to a container or a transport container and it is adapted for an intended interaction with the magnetic actuator during the coupling. Especially preferably, the coupling element is designed corresponding to the magnetic actuator, so that certain intended regions of the coupling element interact upon coupling with certain intended regions of the magnetic actuator in an intended manner in order to produce the coupling.

It is especially advantageous when the coupling element and the magnetic actuator have respectively at least one north pole magnetic element and at least one south pole magnetic element, wherein the magnetic actuator can be brought optionally into a first orientation or a second orientation relative to the coupling element, wherein the magnetic elements in a first orientation interact such that an attracting magnetic force is created from the magnetic actuator to the coupling element and wherein the magnetic elements in a second orientation interact such that a repelling magnetic force is created from the magnetic actuator to the coupling element.

Furthermore, it is advantageous when a third orientation is also provided in addition to the first orientation and the second orientation, in which both attracting magnetic forces and repelling magnetic forces interact such that no resulting force from the magnetic actuator impinges on the coupling element.

Moreover, it is advantageous when north pole magnetic elements and south pole magnetic elements are arranged in alternation on a track circulating about an axis of rotation of the magnetic actuator, so that a first orientation or a second orientation of the magnetic actuator relative to the coupling element can be produced optionally by a turning of the magnetic actuator about the axis of rotation.

Preferably, corresponding arrangements of north pole magnetic elements and south pole magnetic elements exist on the coupling element and the magnetic actuator.

Each north pole magnetic element and each south pole magnetic element preferably itself has a north pole and a south pole. The term “north pole magnetic element” or “south pole magnetic element” is used preferably when the north pole or south pole are oriented toward the surface on which the magnetic actuator with the conveyed goods (especially with the coupling element) is coupled. The other respective pole of the magnetic element is preferably situated opposite to this.

The described arrangement with north pole magnetic elements and south pole magnetic elements is especially preferably suited to producing a secure coupling between the magnetic actuator and the coupling element.

Furthermore, it is advantageous when the manipulator is arranged in the barrier system lying opposite a docking port, wherein a transfer device for the transport of the conveyed goods to the barrier system can be placed against the docking port and the docking port is adapted to form an outwardly sealed passageway from the transfer device to the barrier system, while the conveyed goods can be transported with the magnetic actuator from the transfer device through the passageway to the docking port and the barrier system.

The transfer device preferably forms its own small barrier system. The transfer device together with the barrier system preferably forms an overall system, with which it is possible to bring in and take out conveyed goods in the barrier system under barrier system conditions. An inner space of the transfer device, preferably sterile, is provided. Thanks to the connection to the barrier system, the conditions in the barrier system (e.g., clean room conditions) are also preferably established in the transfer device. Prior to uncoupling the transfer device from the barrier system, the transfer device is preferably hermetically sealed, so that the conditions in the barrier system (e.g., clean room conditions) also remain maintained in the transfer device.

The transfer device can preferably be docked at a docking port of the barrier system. The transfer device and the docking port preferably form a circulating sealed connection within which a sealed passageway can be produced.

Furthermore, it is advantageous when the docking port comprises a first door, which closes the docking port, and wherein the transfer device comprises a second door, which closes the transfer device, while the docking port is adapted to interact with the transfer device such that the first door and the second door are opened when the outwardly sealed passageway is established from the transfer device to the docking port and the barrier system.

The transfer device is preferably small in relation to the barrier system. This refers in particular to an inner volume of the transfer device and the barrier system. A sealed passageway from the barrier system (through the docking port) to the transfer device preferably has a relatively small cross section, which is filled up for example by at least 50 percent (preferably even by at least 80 percent) when the conveyed goods have been delivered from the transfer device to the barrier system. The movement of the conveyed goods from the transfer device with the direction of movement occurs preferably with the magnetic acting direction of the magnetic actuator, which is parallel to the direction of movement. Thanks to the use of a magnetic actuator with such an orientation of the magnetic acting direction, the magnetic actuator can be coupled to the conveyed goods from an end face and needs no addi-tional room, such as would be the case with a grip which would have to reach around the conveyed goods. For this reason, especially large conveyed goods in relation to the transfer device can be processed with the device described here.

A further advantage of a magnetic actuator having such an orientation of the magnetic acting direction is that no movement into the transfer device is necessary thanks to the magnetic actuator at the end face. This is especially advantageous when the transfer device has a different clean room classification. This is normally not the case with RTP port systems, but more so for an entry or exit bulkhead through which a standard material flow occurs during production. Incoming transport of empty packaging/containers and outgoing transport of filled packaging/containers or also reject items.

Such entry or exit bulkheads are often not fully closed, such as is the case with the transfer device described here and its connection to the barrier system. Such entry or exit bulkheads often employ a protection against contamination of the barrier system by excess pressure in the interior of the barrier system (in the case of a clean room) or by a negative pressure in the interior of the barrier system (in the case of a system for handling of contaminated samples or products). While a classical grip needs to reach around an object and thus protrudes at least partly from an entry or exit bulkhead or overlaps with the object inside the entry or exit bulkhead, with the magnetic actuator described here it is possible for the contact between the object and the magnetic actuator to occur only in a single plane. Thus, the protection against contamination is significantly improved thanks to the use of the actuator described here in connection with an entry or exit bulkhead.

Preferably, a guide is present, making possible a guiding of the conveyed goods from the transfer device to the barrier system once the sealed passageway has been produced. This guide may comprise guide rails, for example, which run from the transfer device through the passageway and into the barrier system or vice versa.

Thanks to the device described here, it is also possible to place the conveyed goods in the correct position when they are being removed from the transfer device. In this way, an automated unloading process can be carried out for the preferred case when the conveyed goods are a container or a transport container.

The positioning between the magnetic actuator and the conveyed goods or the container or transport container in the case of the device described here can deal with significantly more uncertainty in terms of the positioning than in the case of a form-fitting connection with a grip, for example. If the orientation does not fit precisely, the system is not over-determined, and in particular no jamming can occur.

As mentioned, the magnetic force acts in the direction of movement. A further benefit of this orientation is that the play in a guide given this orientation has an impact on the air gap of the magnet. This, in turn, has a positive influence on the process safety. In particular, thanks to the acting direction of the magnet being in the direction of movement, no attraction occurs such as would increase a frictional resistance to a movement of the conveyed goods.

Thus, a significant feature of the device described here is that the conveyed goods (here, a container or transport container with samples) are drawn into the barrier system by means of magnetic force. The linear movement of the conveyed goods can be performed in an automated manner with the manipulator. Magnets need not be arranged without exception on the magnetic actuator. It is also possible for there to be only one coupling element with magnetic elements arranged on the conveyed goods, which interacts with magnetisable elements on the magnetic actuator in order to couple the conveyed goods to the magnetic actuator. Magnetic elements can be welded, press-fitted, cast, glued or screwed in the magnetic actuator and/or the coupling element. When the conveyed goods are a container for samples, a removal of samples or an unloading or loading of the container or transport container can be done (after the conveyed goods have been pulled into the barrier system).

In preferred variant embodiments, a coupling and uncoupling of the conveyed goods occurs by a rotating of the magnetic actuator. Once the unloading or loading process is complete, the conveyed goods or the container or transport container are preferably pushed back into the transfer device. For this, one can utilize the effect that like magnetic poles repel each other. Hence, the magnets on the conveyed goods and on the magnetic actuator are preferably arranged such that north pole stands opposite north pole and south pole opposite south pole. This can be accomplished in a magnetic actuator or a coupling element each having two north pole magnetic elements and two south pole magnetic elements in that the magnetic actuator starting from an orientation in which north pole magnetic elements and south pole magnetic elements are attracting each other is rotated through 90° and brought into an orientation in which the north pole magnetic elements and south pole magnetic elements are repelling each other. The number and size of the north pole magnetic elements and south pole magnetic elements can be chosen flexibly according to the required magnetic force and avail-able design space. The minimum number is precisely one magnet on the magnetic actuator and/or on the coupling element as well as one material interacting magnetically with the magnet on the respective other element (coupling element or magnetic actuator). A further variant embodiment is one magnet on each side (on the magnetic actuator and the coupling element). Thanks to the opposite poles, larger forces can be achieved, so that heavy conveyed goods can be pulled out from transfer devices. By rotation of the magnetic actuator, the effective force of the magnetic elements can be reduced continuously. Preferably, there exists a neutral position in which attracting and repelling magnetic forces cancel each other out between the magnetic actuator and the coupling element.

No intervention by operators is necessary thanks to the automated movement of the conveyed goods. This eliminates the operator as a source of errors. This makes sure that the conveyed goods are brought into the desired, exactly defined position in automated manner. This is the prerequisite for a safe process sequence, especially in the case of an automated unloading and loading of a transport container as the conveyed goods by a further handling system for the handling of samples arranged in the transport container.

In order to improve the positioning accuracy of the conveyed goods or a container or transport container as the conveyed goods in the barrier system, a centring aid can be arranged at the entrance. This centring aid may consist of a centring bolt and a centring sleeve, for example.

There shall also be described here a barrier system having at least one described device for the handling of conveyed goods within the barrier system.

It should be pointed out that the special benefits and configuration features described in connection with the above-described device can also be applied and transferred to the barrier system.

The barrier system in particular can have all the features presented in connection with the described device and it can likewise form an overarching unit for the described device. It is also possible for both the barrier system and the device to form components of an (overarching) processing systems for products and/or samples. A clear distinction between features of the barrier system and those of the device might not even be possible in this case. In other words: certain features might form both a component of the barrier system and of the device. This includes, for example, the docking port, which is part of the barrier system and at the same time also part of the device, as it interacts with the manipulator as described above.

The barrier system is especially suitable for pharmaceutical applications. A special focus for the barrier system is that undesirable substances cannot emerge from the barrier system. Especially for pharmaceutical applications a special focus is for barrier systems to work in this way, since pharmaceutical substances for various reasons should not get acci-dentally into the surroundings and produce a contamination there. This is one distinction from pure clean room barrier systems, where it can be assumed that the processed products or samples in the interior of the barrier system are pure in any case and no contaminants can arise from them. In the case of such pure clean room barrier systems the focus is usually placed primarily on preventing impurities/contaminants from getting into the barrier system.

The barrier system can preferably also be adapted to work in a bidirectional manner, so that it prevents both a contamination of processed products or samples in the barrier system by the surroundings and a contamination of the surroundings by processed products or samples in the barrier system.

Depending on the application, the barrier system can be used for the processing of pharmaceutical products and/or for the processing of samples. This includes the processing of samples in laboratory conditions for research purposes or for purposes other than research (such as clinical practice).

### BRIEF DESCRIPTION OF THE DRAWINGS

The invention and the technical environment of the invention shall be explained more closely in the following with the aid of the figures. The figures show preferred exem-plary embodiments, without the invention being limited to them. It should be pointed out in particular that the figures and especially the size relations shown in the figures are only schematic. There are shown:

FIG. 1: a schematic representation of a described device, and

FIG. 2: a front view of a magnetic actuator of a described device.

### DETAILED DESCRIPTION

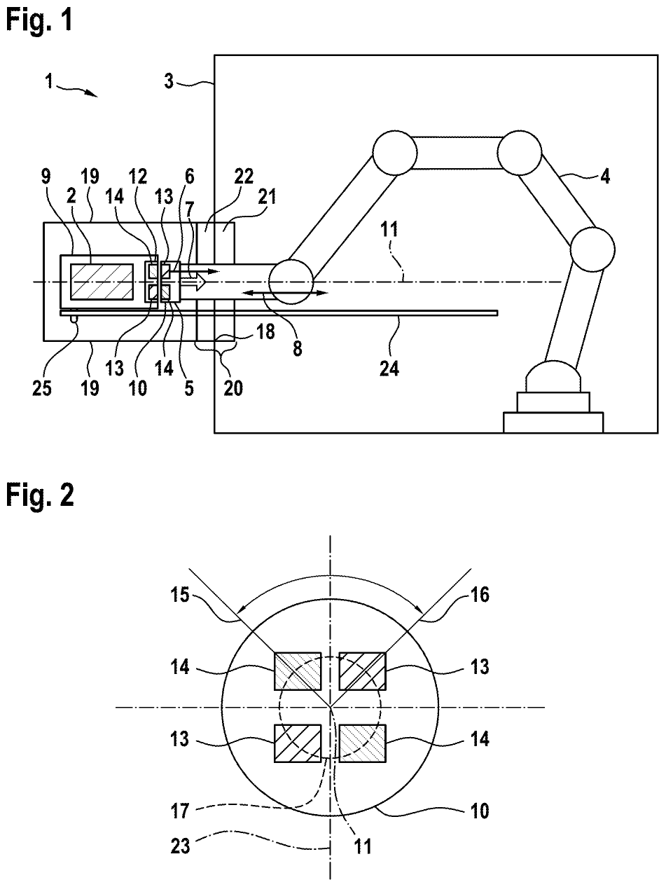

FIG. 1 shows a described device 1 having a barrier system 3 as well as a manipulator 4 arranged in the barrier system 3. The manipulator 4 is preferably electrically operated and it is adapted to carry out the transport and the processing of conveyed goods 2 within the barrier system 3. The conveyed goods 2 can be, for example, a sample or a sample array, consisting of a number of individual samples, which are being subjected to a special investiga-tion or handling in the barrier system 3. In the schematic FIG. 1, means for performing the in-vestigations and processing of the sample are not shown.

The conveyed goods 2 can preferably be brought into the barrier system 3 with a transfer device 19. The transfer device 19 is preferably a closed space, which can be hermetically sealed off for the transport of the conveyed goods 2, in order to maintain the purity of the conveyed goods 2. The transfer device 19 preferably forms a kind of barrier system in itself. The transfer device 19 can preferably be closed off at a docking port 18 of the barrier system 3 so that an outwardly sealed (outside the barrier system 3) passageway 20 can be produced, through which the conveyed goods 2 can be moved from the transfer device 19 to the barrier system 3. The transfer device 19 in particular is suited to transporting the conveyed goods from one barrier system 3 to another barrier system 3, in which case both clean rooms 3 each have a described docking port 18. The docking port 18 of the barrier system 3 preferably has a first door 21, with which the docking port 18 can be closed when no transfer device 19 is connected to it. The transfer device 19 preferably has a second door 22, with which the transfer device 19 can be closed when the transfer device 19 is not connected to a docking port 18 of a barrier system 3. The transfer device 19 and the docking port 18 preferably interact such that the first door 21 and the second door 22 are opened when the sealed passageway 20 is produced from the transfer device 19 to the docking port 18 and the barrier system 3. Preferably, upon connecting the transfer device 19 to the docking port 18 a coupling of the first door 21 and the second door 22 occurs, so that both doors 21, 22 can be opened at the same time. When the transfer device 19 and the docking port 18 are tightly connected to each other, an opening of the doors 21, 22 occurs, preferably automatically, in that a door opening mechanism is activated.

The conveyed goods 2 are preferably taken up in a transport container 9, with which the conveyed goods 2 can be transported.

The manipulator 4 preferably has a manipulator head 10 with a magnetic actuator 5. Especially preferably, the magnetic actuator 5 with the manipulator head 10 can turn about the axis of rotation 11. The transport container 9 for the conveyed goods 2 preferably has a coupling element 12. The magnetic actuator 5 is designed to be coupled to the coupling element 12 and then to move the transport container 9 and the conveyed goods 2 with the manipulator 4. The magnetic actuator 5 and the coupling element 12 preferably have magnetic elements 13, 14, and preferably both the magnetic actuator 5 and the coupling element 12 each have north pole magnetic elements 13 and south pole magnetic elements 14. Each of the north pole magnetic elements 13 of the magnetic actuator 5 attract south pole magnetic elements 14 of the coupling element 12 and vice versa. The interaction of the north pole magnetic elements 13 and the south pole magnetic elements 14 of the magnetic actuator 5 and the coupling element 12 shall be described more closely below with the aid of FIG. 2. An attrac-tive magnetic force 7 or a repulsive magnetic force 7 between the magnetic actuator 5 and the coupling element 12 acts with a magnetic acting direction 6. The device 1, especially the manipulator 4 of the device 1, is preferably adapted to bring about a movement of the conveyed goods 2 or the transport container 9 in a direction of movement 8 having at least one direc-tional component which is parallel to the magnetic acting direction 6. FIG. 1 shows a variant embodiment in which the direction of movement 8 of the conveyed goods 2 or the transport container 9 is parallel to the magnetic acting direction 6.

A preferred layout of the magnetic actuator 5 shall be explained with the aid of FIG. 2. FIG. 2 shows the magnetic actuator 5 in a front view, which is represented in FIG. 1 with the viewing direction A. The magnetic actuator 5 can preferably turn about an axis of rotation 11, which is represented in FIG. 1 and in FIG. 2. The magnetic actuator 5 preferably has an even number of north pole magnetic elements 13 and an even number of south pole magnetic elements 14, which are arranged here distributed about the axis of rotation 11 on a circulating track 17. In the variant embodiment of FIG. 2, precisely two north pole magnetic elements 13 and two south pole magnetic elements 14 are present.

The magnetic actuator 5 is designed to interact with a coupling element 12, having an arrangement of north pole magnetic elements 13 and south pole magnetic elements 14 corresponding to the arrangement shown in FIG. 2 for the magnetic actuator 5. A degree of overlap or superpositioning of north pole magnetic elements 13 and south pole magnetic elements 14 of the magnetic actuator 5 and the coupling element 12 depends on the angular orientation of the magnetic actuator 5 and the coupling element 12 relative to the axis of rotation. By rotating the magnetic actuator 5, this degree of overlap or superpositioning can be deliberately adjusted. A first orientation 15 can be adjusted in which the north pole magnetic elements 13 of the magnetic actuator 5 are arranged precisely opposite the south pole magnetic elements 14 of the coupling element 12 and vice versa, so that a (maximum) attraction is achieved between the magnetic actuator 5 and the coupling element 12. A second orientation 16 can be adjusted in which the north pole magnetic elements 13 of the magnetic actuator 5 are arranged precisely opposite the north pole magnetic elements 13 of the coupling element 12, and the same then holds for the south pole magnetic elements 14, so that a (maximum) repulsion is achieved between the magnetic actuator 5 and the coupling element 12. Preferably, a third orientation 23 can also be adjusted, in which repelling forces and attracting forces between the magnetic actuator 5 and the coupling element 12 cancel each other out, so that the magnetic actuator 5 can be moved without this having relevant effects on the coupling element 12. The magnetic actuator 5 can preferably be placed in such a third orientation 23 in order to loosen the magnetic actuator 5 from the coupling element 12 and/or to place the magnetic actuator 5 closer to the coupling element 12 or further away from the coupling element 12, without any uncontrolled effects of the magnetic forces occurring, such as a sudden unintended attraction or repulsion of the coupling element 12.

It may happen that mechanical torques are produced on the coupling element 12 due to rotations of the magnetic actuator 5 about the axis of rotation 11. Such mechanical torques may cause, e.g., a tilting of a transport container 9 for the conveyed goods 2. In order to counteract such mechanical torques during a rotation of the magnetic actuator 5, there is optionally a guide 24 for the transport container 9 or the conveyed goods 2, being shown sche-matically in FIG. 1. Such a guide can be arranged in the barrier system 3 and be extended into the transfer device 19 after producing the sealed passageway 20, or vice versa. Preferably, the transport container 9 or the conveyed goods 2 will be guided by such a guide 24 during the movement out from the transfer device 19 or into the transfer device 19. The guide 24 can interact for example with a guide bolt 25 on the transport container 9, which runs in the guide 24 as in a rail and is adapted to absorb mechanical torques arising from a turning of the magnetic actuator 5 about the axis of rotation 11.

### LIST OF REFERENCE NUMBERS

1 Device
2 Conveyed goods
3 Barrier system
4 Manipulator
5 Magnetic actuator
6 Magnetic acting direction
7 Magnetic force
8 Direction of movement
9 Transport container
10 Manipulator head
11 Axis of rotation
12 Coupling element
13 North pole magnetic element
14 South pole magnetic element
15 First orientation
16 Second orientation
17 Circulating track
18 Docking port
19 Transfer device
20 Passageway
21 First door
22 Second door
23 Third orientation
24 Guide
25 Guide bolt

1. A device (1) for handling of conveyed goods (2) within a barrier system (3), comprising a manipulator (4) arranged in the barrier system (3) and having a magnetic actuator (5) for applying a magnetic force (6) to the conveyed goods (2), having a design-dependent magnetic acting direction (6) of the magnetic force (7), wherein the manipulator (4) is arranged inside the barrier system (3) and is configured for coupling the conveyed goods (2) with the magnetic force (7) to the manipulator (4) and moving the conveyed goods (2) with the manipulator (4) within the barrier system (3).

2. The device (1) according to claim 1, wherein the magnetic actuator (5) comprises at least one electromagnet.

3. The device (1) according to claim 1, wherein the manipulator (4) is configured for moving the conveyed goods (2) with a direction of movement (8) having at least one direction component parallel to the magnetic acting direction (6) of the magnetic force (7).

4. The device (1) according to claim 3, wherein the magnetic acting direction (6) of the magnetic force (7) and the direction of movement (8) of the conveyed goods (2) run in parallel.

5. The device (1) according to claim 1, wherein the conveyed goods (2) comprise a material with magnetic properties.

6. The device (1) according to claim 1, wherein the conveyed goods (2) are a transport container (9) for a material.

7. The device (1) according to claim 1, wherein the magnetic actuator (5) is arranged on a manipulator head (10), which can turn about an axis of rotation (11) oriented parallel to the magnetic acting direction (6).

8. The device (1) according to claim 1, wherein the conveyed goods comprise a coupling element (12) having magnetic properties.

9. The device (1) according to claim 8, wherein the coupling element (12) and the magnetic actuator (5) have respectively at least one north pole magnetic element (13) and at least one south pole magnetic element (14), wherein the magnetic actuator (5) can be brought into a first orientation (15) or a second orientation (16) relative to the coupling element (12), wherein the magnetic elements (13, 14) in a first orientation (15) interact such that an attracting magnetic force (7) is created from the magnetic actuator (5) to the coupling element (12) and wherein the magnetic elements (13, 14) in a second orientation (15) interact such that a repelling magnetic force (7) is created from the magnetic actuator (5) to the coupling element (12).

10. The device (1) according to claim 9, wherein a third orientation (23) is also provided in addition to the first orientation (15) and the second orientation (16), in which both attracting magnetic forces (7) and repelling magnetic forces (7) interact such that no resulting force from the magnetic actuator (5) impinges on the coupling element (12).

11. The device (1) according to claim 9, wherein north pole magnetic elements (13) and south pole magnetic elements (14) are arranged in alternation on a track (17) circulating about an axis of rotation (11) of the magnetic actuator (5), so that a first orientation or a second orientation of the magnetic actuator (5) relative to the coupling element can be produced by a turning of the magnetic actuator (5) about the axis of rotation.

12. The device (1) according to claim 10, wherein north pole magnetic elements (13) and south pole magnetic elements (14) are arranged in alternation on a track (17) circulating about an axis of rotation (11) of the magnetic actuator (5), so that a first orientation or a second orientation of the magnetic actuator (5) relative to the coupling element can be produced by a turning of the magnetic actuator (5) about the axis of rotation.

13. The device (1) according to claim 1, wherein the manipulator (4) is arranged in the barrier system (3) lying opposite a docking port (18), wherein a transfer device (19) for the transport of the conveyed goods (2) to the barrier system (3) can be placed against the docking port (18) and the docking port (18) is adapted to form an outwardly sealed passageway (20) from the transfer device (19) to the barrier system (3), while the conveyed goods (2) can be transported with the magnetic actuator (5) from the transfer device (19) through the passageway (20) to the docking port (18) and the barrier system (3).

14. The device (1) according to claim 13, wherein the docking port (18) comprises a first door (21), which closes the docking port (18), and wherein the transfer device (19) comprises a second door (22), which closes the transfer device (19), while the docking port (18) is adapted to interact with the transfer device (19) such that the first door (21) and the second door (22) are opened when the outwardly sealed passageway (20) is established from the transfer device (19) to the docking port (18) and the barrier system (3).

15. A barrier system (3), comprising at least one device (1) for handling of conveyed) goods (2) within the barrier system (3) according to claim 1.
